(19) United States
(12) Patent Application Publication
(10) Pub. No.: US 2012/0051346 A1
(43) Pub. Date: Mar. 1, 2012

(54) 3-ADDRESS MODE BRIDGING

(75) Inventors: James HERBERT, Hornsby (AU); Richard KINDER, Eastwood (AU); Hamid MARSHALL, San Jose, CA (US)

(73) Assignee: Quantenna Communications, Inc., Fremont, CA (US)

(21) Appl. No.: 13/217,163

(22) Filed: Aug. 24, 2011

Related U.S. Application Data
(60) Provisional application No. 61/376,500, filed on Aug. 24, 2010.

(51) Int. Cl. H04W 92/10

(52) U.S. Cl. 370/338

(57) ABSTRACT

A technique for utilizing an intermediate access point (IAP) with a wireless access point (WAP) that uses 3-address mode involves making use of a bridge table that includes media access control (MAC) addresses of stations registered with the IAP and internet protocol (IP) addresses of the stations stored in association with the corresponding MAC address. A bridging engine can obtain an IP address from a WAP IP frame and match the IP address to an IP address in the bridge table to find the corresponding MAC address. The bridging engine can encapsulate at least a portion of the WAP IP frame to create an IAP frame with the corresponding MAC address as the receiver address (RA).

### CROSS-REFERENCE TO RELATED APPLICATIONS

The present application claims priority to U.S. Provisional Patent App. No. 61/376,500, filed on Aug. 24, 2010, which is incorporated by reference.

### BACKGROUND

A typical wireless network usually comprises at least one wireless access point (WAP) through which stations can connect to a wireless network. A common wireless network is a Wi-Fi network, which is a non-technical description that is generally correlated with the IEEE 802.11 standards, as well as Wi-Fi Protected Access (WPA) and WPA2 security standards, and the Extensible Authentication Protocol (EAP) standard. A wireless network can include a wireless local area network (WLAN) or a network of some other size.

The IEEE 802.11 specification includes support for using a wireless link as a layer 2 bridge, whereby multiple clients can sit behind a single wireless station (STA) and participate in the same local area network (LAN). This is known (misleadingly) as a Wireless Distribution System (WDS). It requires both the WAP and the STA to support 4-address 802.11 headers. Some STA support 4-address 802.11 headers and are capable of operating in bridge mode, but some WAPs are not. A STA with multiple Ethernet ports will tend to lead to an expectation that more than one client can be connected to them, regardless of the WAP used.

The foregoing examples of the related art are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools, and methods that are meant to be exemplary and illustrative, not limiting in scope. In various embodiments, one or more of the above-described problems have been reduced or eliminated, while other embodiments are directed to other improvements.

A technique for utilizing an intermediate access point (IAP) with a wireless access point (WAP) that uses 3-address mode involves making use of a bridge table that includes media access control (MAC) addresses of stations registered with the IAP and Internet protocol (IP) addresses of the stations stored in association with the corresponding MAC address. A bridging engine can obtain an IP address from a WAP IP packet and match the IP address to an IP address in the bridge table to find the corresponding MAC address. The bridging engine can encapsulate a 3-address mode compliant frame to create an IAP frame with the corresponding MAC address as the receiver address (RA).

The description in this paper describes this technique and examples of systems implementing this technique.

### BRIEF DESCRIPTION OF THE DRAWINGS

Examples of claimed subject matter are illustrated in the figures.

FIG. 1 depicts an example of a system having a 3-address mode wireless access point (WAP) and an intermediate access point (IAP).

FIG. 2 depicts an example of a 3-address mode bridging IAP system.

FIG. 3 depicts a computer system that can be used in other systems described in this paper.

FIG. 4 depicts a flowchart of an example of a method for 3-address bridging at an IAP.

FIG. 5 depicts a flowchart of an example of a method for 3-address bridging at an IAP.

FIG. 6 depicts an example of a system including a 3-address mode wireless network link between a WAP and a wireless end point (WEP) having one or more wire-connected end points (EP).

### DETAILED DESCRIPTION

In the following description, several specific details are presented to provide a thorough understanding of examples of claimed subject matter. One skilled in the relevant art will recognize, however, that one or more of the specific details can be eliminated or combined with other components, etc. In other instances, well-known implementations or operations are not shown or described in detail to avoid obscuring aspects of claimed subject matter.

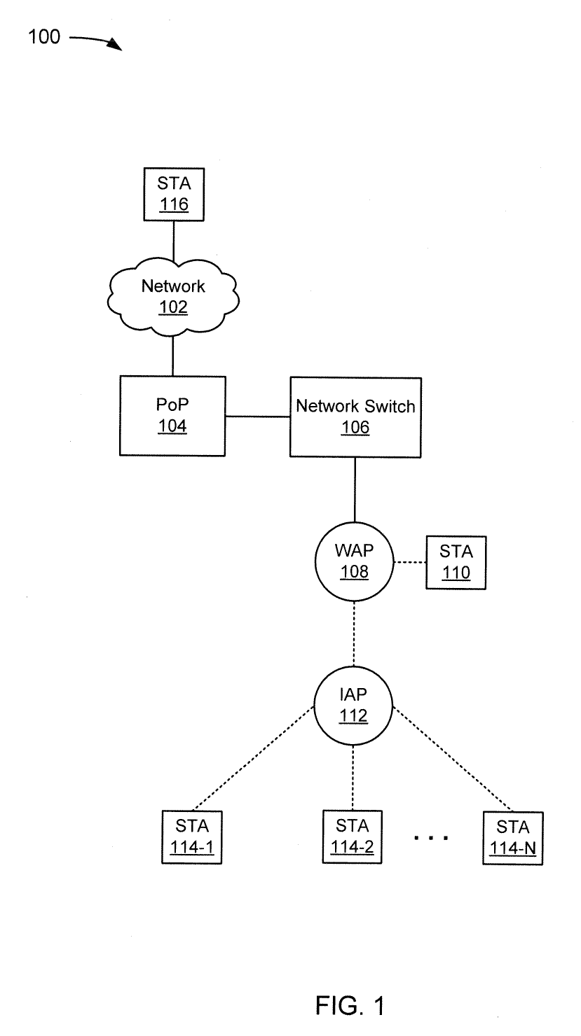

FIG. 1 depicts an example of a system 100 having a 3-address mode wireless access point (WAP) and an intermediate access point (IAP). In the example of FIG. 1, the system 100 includes a network 102, a point of presence (PoP) 104, a network switch 106, a 3-address mode WAP 108, an optional WAP client STA 110, an IAP 112, and IAP client STAs 114-1 to 114-N (collectively, the IAP STAs 114).

In the example of FIG. 1, the network 102 may be practically any type of communications network, such as the Internet. The network 102 can be implemented as a smaller network, such as a wide area network (WAN), metropolitan are network (MAN), campus area network (CAN), or local area network (LAN), but the network 102 could at least theoretically be of any size. Networks that are coupled to the network 102 can be referred to as “on” the network 102. Networks can include enterprise private networks and virtual private networks (collectively, private networks). As the name suggests, private networks are under the control of an entity. Private networks include a head office and optional regional offices (collectively, offices). Many offices enable remote users to connect to the private network offices via some other network, such as the Internet.

In the example of FIG. 1, the PoP 104 includes an access point to the network 102. The term “PoP” is frequently used with reference to an access point to the Internet, but is used more broadly in this paper to mean an access point to the network 102. In a typical implementation, the PoP 104 could include servers, routers, ATM switches, digital/analog call aggregators, etc. The PoP 104 can be part of the facilities of a telecommunications provider that an Internet service provider (ISP) rents or a location separate from a telecommunications provider. The PoP 104 can be referred to as “on” the network 102. In this paper, the PoP 104 is considered to include the components of the system 100 that are under the control of a party that provides access to the network 102 or a service thereof; the party can be referred to as a network service provider (NSP) which is a superset of ISP.

In the example of FIG. 1, the network switch 106 is coupled to the PoP 104. The network switch 106 includes a computer networking device that connects network segments. The network switch 106 can also include port mirroring, firewall, network intrusion detection, performance analysis, and other applicable known or convenient engines. An engine, as used here and elsewhere in this paper, can include a dedicated or shared processor and hardware, firmware, and/or software modules that are executed by the processor of the engine. Depending upon implementation-specific or other considerations, an engine can be centralized or its functionality distributed. An engine can include special purpose hardware, firmware, or software embodied in a computer-readable medium for execution by the processor. As used in this paper, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware. As used in this paper, the term “computer-readable storage medium” is intended to include only physical media, such as memory.

In a specific implementation, the network switch 106 includes a network bridge that processes and routes data in the data link layer (layer 2) of the Open Systems Interconnection (OSI) model. For example, an Ethernet switch operates at the data link layer. However, the network switch 106 could be implemented as a multilayer switch that also processes data at the network layer (layer 3) and/or transport layer (layer 4). A network hub or repeater operates on the physical layer (layer 1) and typically receives data on a port of entry and broadcasts out on every port other than the port of entry. The network switch 106 would not typically be a passive network device such as a hub, which falls outside of the definition of “network switch” as used in this paper, but within the definition of a “networking device” as used in this paper.

The network switch 106 can be implemented in a converged device such as a gateway to access broadband services such as digital subscriber line (DSL) or cable internet. The converged device would typically include components that interface to the particular broadband technology, such as a protocol converter, and can include a telephone interface for voice over Internet Protocol (VoIP). The term “broadband” is a relative term. For example, broadband Internet access is typically contrasted with dial-up access using a 56 k modem. In a specific implementation, the term broadband can be used to mean at least equivalent to a DSL, which is about 70 Mbps. For example, 70 Mbps could include 6 Mbps of Internet access, 30 Mbps of broadcast video, and 35 Mbps of switched digital video (give or take). Ethernet provided over cable modem is a common alternative to DSL; and the term broadband should be interpreted to mean equivalent to that of 100BASE-T Ethernet, as well. In telecommunication, a very narrow band can carry Morse code, a narrow band will carry speech (voiceband), and a still broader band will carry real-time multimedia. Only the latter would normally be considered “broadband.” However, it may be noted that a voice line could be converted to a non-laded twisted-pair wire (no telephone filters) to become hundreds of kilohertz wide (broadband) and can carry several Mbps. Thus, the term broadband in this paper should include equivalents to ADSL, which, depending upon the implemented standard can be from 2 Mpbs to 27.5 Mbps. As another example, digital signal 3 (DS3) is a digital signal level 3 T-carrier, also referred to as a T3 line, with a data rate of 44.736 Mpbs, which would be considered in the “broadband” range. Currently, a sophisticated consumer expectation for broadband range for Internet access would be perhaps 44 Mbps or higher, or perhaps approximately 70-100 Mbps, but it should be understood that the definition of broadband could change over time to include different, presumably higher, Mbps than those just described, and different consumer expectations.

A networking device may or may not include both WAP and network switching functionality. That is, although the network switch 106 and the WAP 108 are illustrated as distinct components, the network switch 106 and the WAP 108 can be implemented as a single physical device, such as a gateway device.

In the example of FIG. 1, WAP 108 can be implemented as part of a small office/home (SOHO) wireless network. As such, the WAP 108 can be implemented as part of a home area network (HAN) or more generally as part of a LAN, where the WAP 108 is referred to as the wireless part of the HAN or LAN, e.g., a wireless HAN (WHAN) or a wireless LAN (WLAN). There is no particular reason to limit the WAP 108 to a SOHO network implementation, but as a network implementation increases in size, the probability increases that there will be multiple network switches 106. The example of FIG. 1 does not illustrate a distinction between different overlapping wireless networks. For instance, a WHAN could include a Wi-Fi network, a bluetooth network, an infrared network, and/or some other type of wireless network, all of which could be treated as part of the wireless network. Alternatively, the different networks could be treated as distinct wireless networks.

As is illustrated in the example of FIG. 1 with dotted lines, wireless STA-to-STA communication is permitted via a known or convenient wireless communications protocol. For illustrative simplicity, it is assumed that the WAP 108 is in wireless communication with at least the IAP 112 (a station), but one of skill in the relevant art would understand that the WAP 108 need not necessarily have any associated stations at any given time. Conceptually, the WAP 108 is not part of an ad hoc network because an infrastructure wireless network will by definition include a WAP.

For illustrative purposes, the WAP 108 can make use of a 3-address mode to communicate with stations. The name of the mode comes from the fact that three addresses are in the header of a frame sent in accordance with the 3-address mode. For example, the WAP 108 can use 3-address mode in communication with the optional WAP client STA 110 and the IAP 112. It may be noted that the WAP client STA 110 is optional because a WAP 108 may or may not be dedicated to communicating with IAPs, one of which is shown by way of example in FIG. 1 as the IAP 112.

The WAP client STA 110, and other stations in this paper, may be defined as a device with a media access control (MAC) address and a physical layer (PHY) interface to a wireless medium that complies with the IEEE 802.11 standard. Thus, for example, the WAP 108 and the IAP 112 can be referred to as stations, if applicable. IEEE 802.11a-1999, IEEE 802.11b-1999, IEEE 802.11g-2003, IEEE 802.11-2007, and IEEE 802.11n TGn Draft 8.0 (2009) are incorporated by reference. As used in this paper, a system that is 802.11 standards-compatible or 802.11 standards-compliant complies with at least some of one or more of the incorporated documents' requirements and/or recommendations, or requirements and/or recommendations from earlier drafts of the documents, and includes Wi-Fi systems. In alternative embodiments, a station may comply with a different standard than IEEE 802.11, may be referred to as something other than a “station,” and may have different interfaces to a wireless or other medium.

When the WAP 108 sends a frame to the WAP client STA 110, the frame includes a receiver address (RA), which can include the MAC address of the WAP client STA 110. The frame includes a transmitter address (TA), which can include the MAC address of the WAP and/or the BSSID. (In at least one implementation, the MAC address of the WAP and the BSSID are the same.) The frame includes a source address (SA), which can include the MAC address of the device from which the frame was originally sent. Three-address mode is sufficient when a WAP 108 communicates exclusively with non-AP STA. However, in the example of FIG. 1, the IAP 112 is located between the WAP 108 and IAP client STAs 114. In 3-address mode, a frame from the WAP 108 bound for one of the IAP client STAs 114 will include the TA (e.g., BSSID) and SA, as normal, but the RA will include the MAC address of the IAP 112.

In the example of FIG. 1, the IAP 112 is defined as a WAP on a wireless network with no wire connection to a broadband access node. The IAP 112 can communicate with the IAP client STAs 114 using, e.g., Bluetooth, Wi-Fi, or some other network standard (or not in accordance with a standard) to form a connection between a non-AP station (the IAP client STAs 114) and an AP station (the IAP 112).

In a specific implementation, the IAP 112 can be connected to a STA through the use of a wireless ‘dongle’ attached to a laptop computer, a wireless-capable television or media centre, or some other device. In another specific implementation, the IAP 112 could be a WAP configured to act as a non-WAP STA and connected to an Ethernet hub or switch, which is also connected to the STAs 114. Advantageously, whereas such a STA would not have enough information to create the Ethernet encapsulation necessary for forwarding data from upstream endpoints to the correct downstream endpoint, the IAP 112 enables such communication.

Thus, the IAP 112 can act as a “router” between one of the IAP client STAs 114 and another of the IAP client STAs 114. The IAP 112 can also communicate with the WAP 108 using, e.g., Wi-Fi or some other network standard to form a connection between a non-AP station and an AP station (from the perspective of the WAP 108). Since the IAP 112 is an AP, an additional engine is necessary to ensure proper state is maintained for communications between the IAP 112 and the WAP 108 where the WAP 108 treats the IAP 112 as a non-AP STA. In a specific implementation, the IAP client STAs 114 can be configured as IAPs, enabling the creation of a chain of wirelessly connected IAPs.

A wireless network can be implemented as a matrix mesh network. Matrix mesh elements are nodes within the wireless network. A mesh is not a “matrix mesh” unless at least one node has multiple antennas and is capable of multiple-input multiple-output (MIMO) functionality. Accordingly, at least one of the matrix mesh elements must have multiple antennas, or at least an antenna with multi-antenna functionality. The matrix mesh elements may or may not include data of their own, but a system can take advantage of matrix mesh element network characteristics in network architecture and/or protocols. In this way, the system can adapt to traffic and/or network demands by optimizing end-to-end transmissions from a client, through at least one of the matrix mesh elements, to a client. One implementation of a matrix mesh network is the VECTOR MESH™ network of Quantenna Communications, Inc. of Sunnyvale, Calif. The VECTOR MESH™ network includes VECTOR MESH™ elements or nodes, and a VECTOR MESH™ network architecture, neighbor discovery protocol, and routing protocol. The IAP 112 can be added to a wireless network including the WAP 108 to introduce matrix mesh functionality. Alternatively, the WAP 108 and the IAP 112 can both be implemented as MIMO devices.

An advantage of implementing a matrix mesh network is that APs trying to reach multiple stations, 3 out of 4 streams could get knocked out and the system would still work. Different streams can survive to get to different stations. It has been shown in a proof of concept that MIMO is more reliable outside than single-input single-output (SISO), and can survive seasonal changes to the environment, such as the elements and foliage growing into the wireless transmission path. In a successful test, poles were placed at between 120 and 170 feet, with intervening obstacles including a thick exterior wall and big trees blocking. The access point locations were approximately 5 feet above the ground, and were operated in the 5 GHz band. The average UDP data rate was 110-120 Mbps and the wireless link rate was 180-200 Mbps. Existing systems have much lower data rates than the proof of concept had.

In most implementations, it is desirable for the IAP 112 to send messages upstream (toward the WAP 108) or downstream (toward the IAP client STAs 114). Since there are multiple IAP client STAs 114, the IAP 112 must be able to differentiate between the IAP client STAs 114 for both upstream and downstream communications. Indeed, if the IAP 112 has multiple Ethernet ports or similar interfaces, there may be an expectation that more than one client can be connected to them, regardless of the capabilities of the WAP 108.

When the WAP 108 sends a frame to the IAP 112, the frame includes an RA, which can include the MAC address of the IAP 112. The frame includes a TA, which can include the MAC address of the WAP and/or the BSSID. The frame includes a SA, which can include the MAC address of the device from which the frame was originally sent. Notably, the RA is that of the IAP 112 rather than that of one of the IAP client STAs 114, even if the intended recipient of the frame is one of the IAP client STAs 114. There is not enough information in the header to route downstream packets to clients behind the IAP 112. In a specific implementation, the 3-address 802.11 header includes only source MAC, BSSID, and station MAC address, but not the MAC address of the destination STA. So the IAP 112 must be able to figure out the destination STA MAC address for a WAP 108 that does not support, e.g., bridging mode.

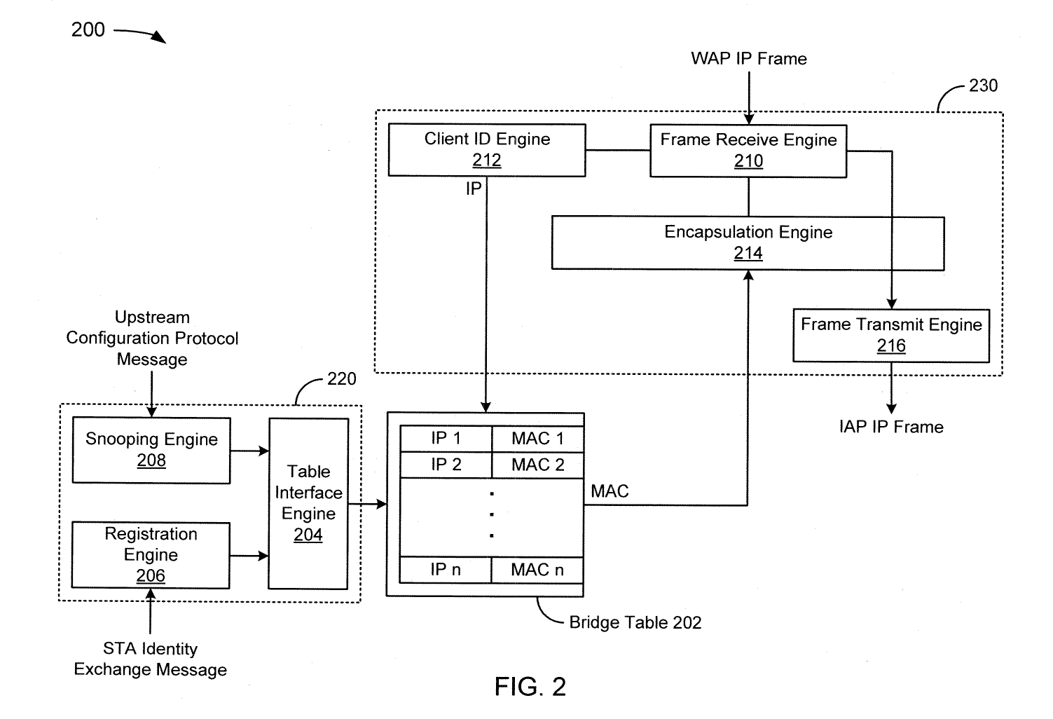

The IAP 112 includes a bridging engine that enables the IAP client STAs 114 to connect transparently to the IAP 112 when the WAP 108 does not support 4-address mode. Advantageously, this can be accomplished with no additional configuration required on either the WAP 108 or the IAP client STAs 114. The bridging engine can be implemented in, e.g., an 802.11 driver of the IAP 112, which can operate independently from the kernel bridge. FIG. 2 depicts an example of a bridging engine.

FIG. 2 depicts an example of a 3-address mode bridging IAP system 200. The system 200 includes a bridge table 202, a table interface engine 204, a registration engine 206, a snooping engine 208, a frame receive engine 210, a client identification (ID) engine 212, an encapsulation engine 214, and a frame transmit engine 216.

In the example of FIG. 2, the bridge table 202 is configured to store client entries. The purpose of the bridge table 202 is to facilitate identification of a STA of a wireless network at an IAP that receives a WAP IP packet. An IP header contains a source IP address and destination IP address; it does not contain MAC addresses. These are present in the encapsulating layer 2 (e.g. Ethernet or 802.11 header). A problem is that a 3-address wireless header contains only the receiving (IAP) MAC address and not the destination (STA) MAC address. (When 4-address wireless headers are used, both of these are present.)

A 3-address wireless frame suitable for 3-address mode bridging will include source MAC, BSSID, and station MAC for the IAP, but will not include the MAC address of the end STA. So the bridge table 202 must have data sufficient to enable identification of the end STA MAC address. This can be accomplished by maintaining an IP address in association with a MAC address of the STA. Thus, in a specific implementation that makes use of IP addresses and MAC addresses, the bridge table 202 includes at least a MAC address and an IP address for each client entry. (Other data may or may not also be stored in the bridge table 202, but such data is ignored for illustrative convenience.)

The bridge table 202 is a datastore. A datastore, as used in this paper, can be implemented, for example, as software embodied in a physical computer-readable medium on a general- or specific-purpose machine, in firmware, in hardware, in a combination thereof, or in an applicable known or convenient device or system. Datastores in this paper are intended to include any organization of data, including tables, comma-separated values (CSV) files, traditional databases (e.g., SQL), or other applicable known or convenient organizational formats. A likely implementation of datastores described in this paper would be in dynamic memory such as RAM, though it could be in persistent memory, and is likely to be created automatically by the system, rather than manually by a user. Reference to datastores as tables or databases is not intended to limit the datastore to any particular format. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus some data structures are based on computing the addresses of data items with arithmetic operations; while other data structures are based on storing addresses of data items within the structure itself. Many data structures use both principles, sometimes combined in non-trivial ways. The implementation of a data structure can entail writing a set of procedures that create and manipulate instances of that structure.

In the example of FIG. 2, the table interface engine 204 stores entries in the bridge table 202. Although the order is not critical, in a specific implementation, the table interface engine 204 first populates the bridge table 202 with MAC addresses of STA that are registered through the IAP 200 on which the bridge table 202 and the table interface engine 204 are implemented. (As was mentioned previously, engines and datastores can be distributed; so implementation on the IAP 200 could be partial and/or virtual.) In a specific implementation that makes use of IP addresses, the table interface engine 204 populates the bridge table 202 with IP addresses associated with STAs that have corresponding MAC addresses in the bridge table 202. The pair of MAC and, e.g., IP address can be referred to as a “client entry” or by some other name, such as “STA record.”

In the example of FIG. 2, the registration engine 206 receives a STA identity exchange message from a STA, and provides a MAC address from the STA identity exchange message to the table interface engine 204, which stores the MAC address in the bridge table 202 as was just described. The exact format of a STA identity exchange message can vary by protocol or implementation. Typically, such a message is sent when a STA associates with and is authenticated at a WAP. Any combination of association, authentication, or other techniques that are used to establish a wireless link between a STA and a wireless network will include at least one STA identity message that can be provided to the table interface engine 204. The term “identity exchange message” is intended to be construed broadly; in a specific implementation, any applicable Dynamic Host Configuration Protocol (DHCP) message sent from a downstream STA can be considered an identity exchange message.

In the example of FIG. 2, the snooping engine 208 snoops an upstream configuration protocol message, such as a DHCP message. DHCP is an automatic configuration protocol used on IP networks. DHCP prevents two computers from accidentally being configured with the same IP address, making the IP address of a STA unique at any given time. (IP addresses can be recycled.) RFC 2131 remains as of 2011 the standard for IPv4 networks. DHCPv6 is documented in RFC 3315. RFC 2131 and RFC 3315 are incorporated by reference. A configuration protocol message can be a discovery, offer, request, or acknowledgement message, or some other message that includes the requisite information. The snooping engine 208 provides an IP address from the configuration protocol message to the table interface engine 204, which stores the IP address in the bridge table 202 as was described above.

In the example of FIG. 2, the table interface engine 204, the registration engine 206, and the snooping engine 208 are enclosed in a dashed box 220 that can be referred to in the aggregate as a bridge table building engine. Some or all of the components of the bridge table building engine can be implemented in a driver. In a specific implementation, the bridging table building engine snoops upstream DHCP messages and uses the contents to build a table of client MAC and IP addresses. The bridge table building engine is not limited to the use of the registration engine 206 and could, in an alternative, obtain both MAC addresses and IP addresses by snooping upstream messages.

An antenna array is conceptually located at the periphery of the dashed box 220 between components of the bridge table building engine and messages received over a wireless medium. An antenna may or may not be located between the bridge table 202 and the table interface engine 204. Generally as used in this paper, an antenna array includes multiple antennas coupled to a common source or load to produce a directive radiation pattern. The spatial relationship can contribute to the directivity of the antennas. Multiple antennas can be configured as part of a multiple-input multiple-output (MIMO) system. It should be noted that multiple-input and single-output (MISO), single-input and multiple-output (SIMO), and single-input and single-output (SISO) are special cases of MIMO. MISO is when the receiver employs a single antenna. SIMO is when the transmitter employs a single antenna. SISO is when neither the transmitter nor the receiver are employing multiple antennas. As used in this paper, techniques may be applicable to any of these special cases, depending upon whether the techniques can be used with one Tx antenna and/or one Rx antenna. Thus, the acronym MIMO could be considered to include the special cases, if applicable. The techniques may also be applicable to multi-user MIMO (MU-MIMO), cooperative MIMO (CO-MIMO), MIMO routing, OFDM-MIMO, or other MIMO technologies. Due to the nature of the techniques described in this paper, a single antenna is as applicable as multiple antennas to employ many of the techniques; so occasionally the antenna array can refer to either or both of a single- or multiple-antenna antenna array and can be described as “an antenna.”

An antenna array is conceptually located at the periphery of the dashed box 230 between components of a bridging engine (comprising the frame receive engine 210, the client ID engine 212, the encapsulation engine 214, and the frame transmit engine 216) and messages received over a wireless medium. An antenna may or may not be located between the bridge table 202 and the client ID engine 212.

In the example of FIG. 2, the client receive engine 210 receives a WAP IP packet. The term “packet” can refer to a data packet on Layer 3 of the OSI model. The term “frame,” on the other hand, can refer to a data packet on Layer 2 of the OSI model. Examples are Ethernet frames, PPP frames, and V.42 frames. Depending upon the context, frames and packets can refer to other layers of the OSI model. As used in this paper, when a WAP IP packet or payload thereof is encapsulated in a Layer 2 frame, the frame can be referred to as a WAP IP frame. A WAP (see FIG. 1) transmits the WAP IP frame, over the air, and is received by the frame receive engine 210, which can include a dedicated or shared antenna. In this example, the WAP IP frame is 3-address mode compliant, and includes the IAP MAC address in a receiver address (RA) field of the header. In alternative implementations, some other analogous identifier and/or field could be used to identify the IAP as the recipient of the frame, when the frame is intended for a STA further downstream.

The client ID engine 212 can use the IP address associated with the WAP IP frame to find a corresponding client entry in the bridge table 202. When there is a match, the client ID engine 212 provides the corresponding MAC address to the encapsulation engine 214.

The encapsulation engine 214 can use an IP address associated with the WAP IP frame received at the frame receive engine 210 to identify the STA to which the frame should be sent. In a specific implementation, the RA field of the WAP IP frame contains the IAP MAC address when the 3-address frame is received at the frame receive engine 210. The encapsulation engine 214 creates an IAP frame with the MAC address of the STA that is the intended recipient of the frame in the RA field. The IAP frame can include the IAP MAC address in the transmitter address (TA) field of the header, if desired. In alternative implementations, some other analogous identifier and/or field could be used to identify the STA as the recipient of the frame and/or the IAP as the transmitter of the frame.

The frame transmit engine 216 sends the IAP frame. The example of FIG. 2 primarily illustrates components associated with sending frames downstream through the IAP 200. Regarding upstream transmission, when the STA sends a frame to the IAP 200, the frame will likely include a RA field, which can contain the MAC address of the IAP 200. The frame will likely include a TA field, which can contain the MAC address of the STA. The frame will likely include a destination address (DA) field, which can contain the MAC address of the intended ultimate recipient of the frame. The IAP 200 knows the MAC address of the WAP and can, depending upon the implementation, encapsulate the frame to identify the WAP or modify the header of a frame to replace the contents of the RA field with the MAC address of the WAP. Thus, the bridging engine 230 can be used in an upstream direction (e.g., the frame receive engine 210 receives a STA IP frame, the encapsulation engine 214 encapsulates so as to include the MAC address of the WAP as the RA, if necessary, and the frame transmit engine 216 transmits the upstream frame to the WAP) without a particular need to implicate the bridge table building engine 220.

In the example of FIG. 2, the frame receive engine 210, the client ID engine 212, the encapsulation engine 214, and the frame transmit engine 216 are enclosed in a dashed box 230 that can be referred to in the aggregate as a bridging engine. Some or all of the components of the bridging engine can be implemented in a driver. In a specific implementation, the bridging engine uses the IP address in an encapsulated IP frame received from a WAP to find a corresponding STA entry in the bridge table 202 and encapsulates with a header that includes the corresponding STA MAC address before forwarding the packet to the kernel bridge.

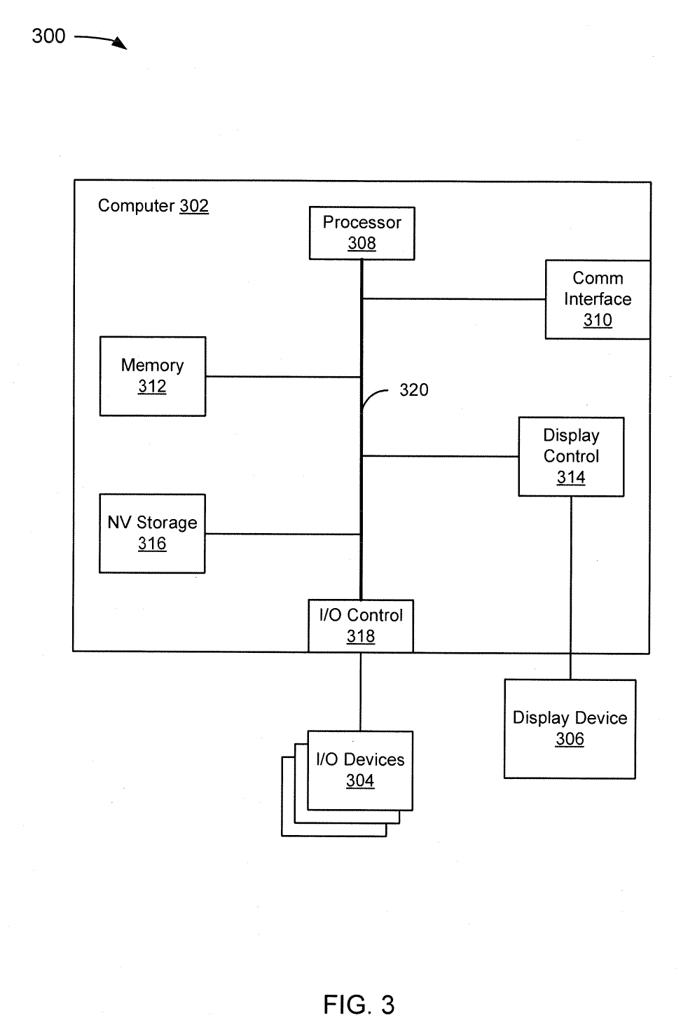

FIG. 3 depicts a computer system 300 that can be used in the system 100 (FIG. 1) or IAP 200 (FIG. 2). The computer system 300 may be a conventional computer system that can be used as a client computer system, such as a wireless client or a workstation, or a server computer system. The computer system 300 includes a computer 302, I/O devices 304, and a display device 306. The computer 302 includes a processor 308, a communications interface 310, memory 312, display controller 314, non-volatile storage 316, and I/O controller 318. The computer 302 may be coupled to or include the I/O devices 304 and display device 306. Stations, including APs, will not necessarily need all of the components, but will typically include at least the processor 308, the communications interface 310, and the memory 312.

The computer 302 interfaces to external systems through the communications interface 310, which may include a radio interface, network interface, or modem. It will be appreciated that the communications interface 310 can be considered to be part of the computer system 300 or a part of the computer 302. The communications interface 310 can include a radio, an analog modem, ISDN modem, cable modem, token ring interface, satellite transmission interface (e.g. “direct PC”), or other interfaces for coupling a computer system to other computer systems.

The processor 308 may be, for example, a conventional microprocessor such as an Intel Pentium microprocessor or Motorola power PC microprocessor. The memory 312 is coupled to the processor 308 by a bus 320. The memory 312 can be Dynamic Random Access Memory (DRAM) and can also include Static RAM (SRAM). The bus 320 couples the processor 308 to the memory 312, also to the non-volatile storage 316, to the display controller 314, and to the I/O controller 318.

The I/O devices 304 can include a keyboard, disk drives, printers, a scanner, and other input and output devices, including a mouse or other pointing device. The display controller 314 may control in the conventional manner a display on the display device 306, which can be, for example, a cathode ray tube (CRT) or liquid crystal display (LCD). The display controller 314 and the I/O controller 318 can be implemented with conventional well known technology.

The non-volatile storage 316 is often a magnetic hard disk, an optical disk, or another form of storage for large amounts of data. Some of this data is often written, by a direct memory access process, into memory 312 during execution of software in the computer 302.

The computer system 300 is one example of many possible computer systems which have different architectures. For example, personal computers based on an Intel microprocessor often have multiple buses, one of which can be an I/O bus for the peripherals and one that directly connects the processor 308 and the memory 312 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 312 for execution by the processor 308. A typical computer system will usually include at least a processor, memory, and a bus coupling the memory to the processor.

In addition, the computer system 300 can be controlled by operating system software which includes a file management system, such as a disk operating system, which is part of the operating system software. One example of operating system software with its associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage 316 and causes the processor 308 to execute the various acts required by the operating system to input and output data and to store data in memory, including storing files on the non-volatile storage 316.

An example of a system 300 that might function as a WAP includes an N×M antenna array, a system in package (SiP), and a power source. As used in this paper, a SiP is a number of integrated circuits enclosed in a single package that performs most of the functions of an electronic system, in this specific example a MIMO station. SiP dies containing integrated circuits can be stacked vertically on a substrate and connected by wires. Slightly less dense multi-chip modules can also be used, which place dies on the same plane; and three-dimensional integrated circuits having stacked silicon dies with conductors running through the die can be used. The N×M antenna array can include one or more antennas. (It may be noted that an array of one antenna is normally not referred to as an “array,” but the distinction is not critical to an understanding of the example.) Where there are multiple antennas in the array, the antennae can be coupled to a common source or load to produce a directive radiation pattern. The spatial relationship can contribute to the directivity of the antennae. The SiP likely includes an RF front end, a (for example) GbE switch, a digital MIMO processing block, and a power input block. A current implementation provides 0.3 Gbps per unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Systems described in this paper may be implemented on any of many possible hardware, firmware, and software systems. Typically, systems such as those described in this paper are implemented in hardware on a silicon chip. Algorithms described in this paper are implemented in hardware, such as by way of example but not limitation RTL code. However, other implementations may be possible. The specific implementation is not critical to an understanding of the techniques and the claimed subject matter.

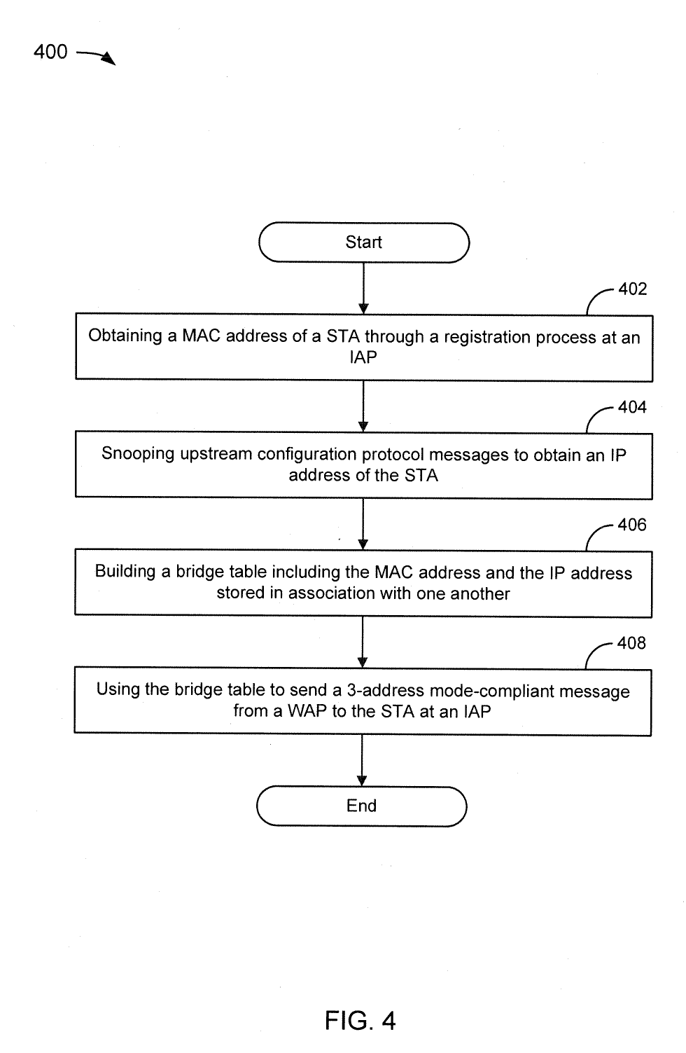

FIG. 4 depicts a flowchart 400 of an example of a method for 3-address bridging at an IAP. Although this figure depicts functional modules in a particular order for purposes of illustration, the process is not limited to any particular order or arrangement. One skilled in the relevant art will appreciate that the various modules portrayed in this figure could be omitted, rearranged, combined and/or adapted in various ways.

In the example of FIG. 4, the flowchart 400 starts at module 402 with obtaining a MAC address of a STA through a registration process at an IAP. The registration process is intended to encompass any process, such as an association or authentication process or a portion thereof, that enables the IAP to obtain a MAC address for a STA in wireless communication with the IAP. The registration can be initiated for a STA that comes within range of the IAP, a STA that roams from another WAP in the same extended service set (ESS) or same private network, a STA that attempts re-registration after a link is dropped, or another applicable instance where the IAP can learn of the STA.

In the example of FIG. 4, the flowchart 400 continues to module 404 with snooping upstream configuration protocol messages to obtain an IP address of the STA. In an 802.11-compliant implementation, the configuration protocol messages are likely to be DHCP messages. Although characterized as “upstream” configuration protocol messages, it should be noted that the upstream refers to where the IP address assignment occurs (e.g., at a DHCP server). The IP address will actually be provided to a STA in at least some implementations, which means a snooping engine can snoop a message that is being sent downstream to the STA.

In the example of FIG. 4, the flowchart 400 continues to module 406 with building a bridge table including the MAC address and the IP address stored in association with one another. A bridge table building engine can obtain the MAC address of a STA through a registration process (204) and the IP address through snooping configuration protocol messages (206). The bridge table building engine can alternatively obtain the MAC address and IP address through snooping configuration protocol messages, since such messages can include both a MAC address and an IP address for a STA.

In the example of FIG. 4, the flowchart 400 continues to module 408 with using the bridge table to send a 3-address mode-compliant message from a WAP to a STA at an IAP. A message can be referred to as “3-address mode-compliant” if the message is bound for the STA, but does not include the MAC address of the STA in the header. Using the bridge table entails looking up in the bridge table an IP address from WAP IP packet data and finding a corresponding MAC address. The IP address and the MAC address will be the IP address and the MAC address of the STA. The received frame can then be encapsulated with a header in which the MAC address in the RA field is that of the STA.

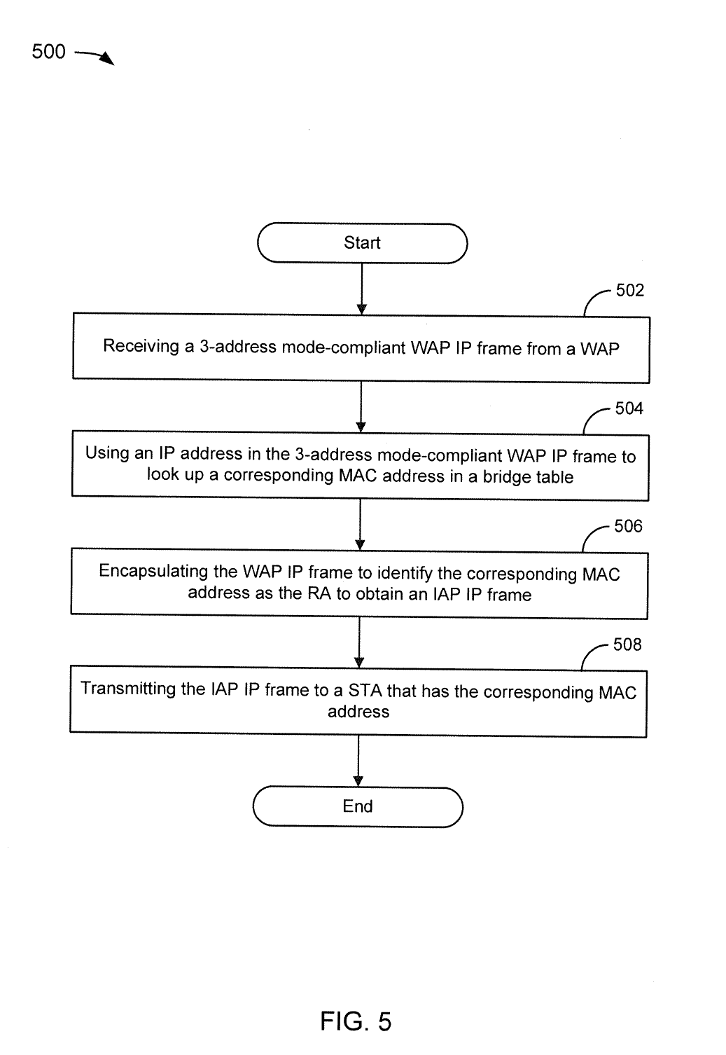

FIG. 5 depicts a flowchart 500 of an example of a method for 3-address bridging at an IAP. The flowchart 500 is intended to illustrate an example of using the bridge table to send a 3-address mode-compliant message from a WAP to a STA at an IAP (see, e.g., FIG. 4, 408).

In the example of FIG. 5, the flowchart 500 starts at module 502 with receiving a 3-address mode-compliant WAP IP frame from a WAR When the 3-address mode-compliant WAP IP frame is received at an IAP, the RA field will contain the MAC address of the IAP. Since the other two fields of the 3 addresses will contain the MAC address of the sender (SA) and the MAC address of the WAP (TA), the MAC address of a STA registered with the IAP will not be found in the header.

In the example of FIG. 5, the flowchart 500 continues to module 504 with using an IP address in the 3-address mode-compliant WAP IP frame to look up a corresponding MAC address in a bridge table. The bridge table can store MAC addresses of STAs that are registered or otherwise associated with the IAP and corresponding IP addresses for the STAs. In the example of FIG. 5, it is presumed that the bridge table includes the IP address and MAC address of a STA that is the intended recipient of a WAP IP packet, as identified by an IP address in the WAP IP packet. Using the IP address as a key, the corresponding MAC address of the STA can be found in the bridge table.

It is possible to chain multiple IAPs together where a first IAP that is upstream relative to a second IAP modifies the RA field from its own MAC address to that of the second IAP, and the second IAP modifies the RA field from its own MAC address to that of the STA for which the frame is intended (or to the next IAP in the chain). Alternatively, the first IAP could convert the WAP IP packet to a 4-address format that includes an RA (the second IAP) and a DA (the destination MAC address). The second IAP would still modify the TA and the RA, but the SA and the DA could be unchanged to the end of the chain.

In the example of FIG. 5, the flowchart 500 continues to module 506 with encapsulating the WAP IP frame to identify the corresponding MAC address as the RA to obtain an IAP IP frame. Depending upon the implementation, there may be changes made to the WAP IP frame. However, a likely implementation that yields an IAP IP frame from a WAP IP frame is encapsulation of the WAP IP frame or the corresponding WAP IP packet.

In the example of FIG. 5, the flowchart 500 continues to module 508 with transmitting the IAP IP frame to a STA that has the corresponding MAC address. Depending upon the implementation, the IAP IP frame need not be a “frame” in the sense that it may or may not include a Layer 2 transmission.

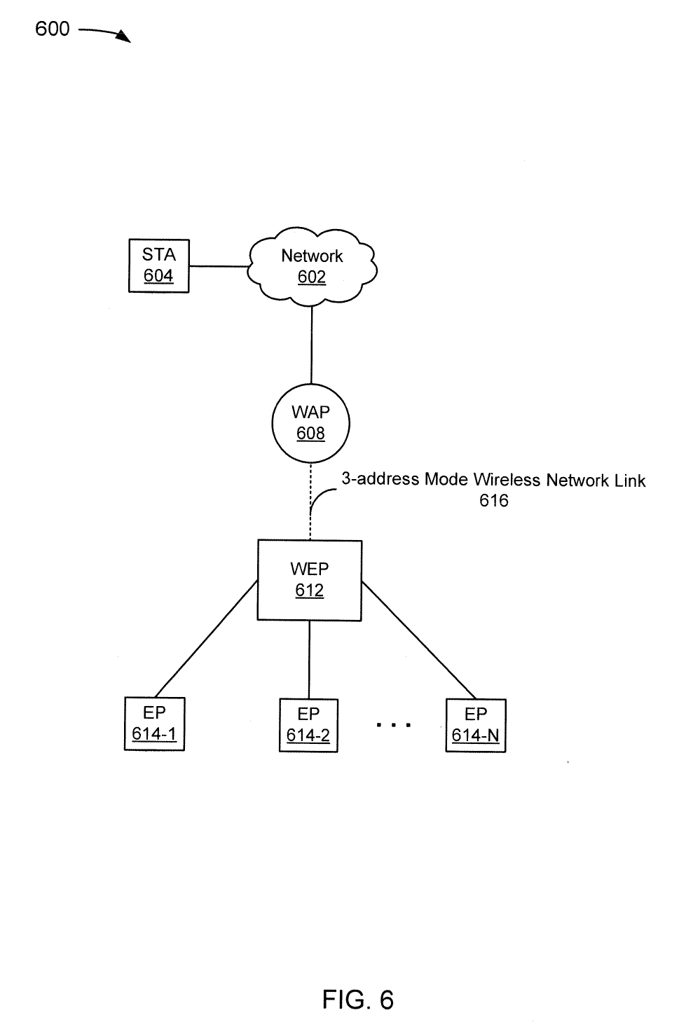

FIG. 6 depicts an example of a system 600 including a 3-address mode wireless network link between a WAP and a wireless end point (WEP) having one or more wire-connected end points (EP). In the example of FIG. 6, the system 600 includes a network 602, a STA 604, a WAP 608, a WEP 612, and EPs 614-1 to 614-N (referred to collectively as the EPs 614).

In the example of FIG. 6, the network 602 can include a backbone network to which the WAP 608 is coupled, though any applicable network 602 can be used. The STA 604 is coupled to the network 602 for illustrative purposes, to serve as a sender or receiver of messages in the examples that follow. The STA 604 can be implemented as any applicable device. In general, communications between the STA 604 and the WAP 608 over the network 602 can be over any applicable medium capable of carrying such traffic.

The WAP 608 is configured for 3-address mode communications. In a specific implementation, the term “3-address mode” refers to an 802.11 wireless network in which frames are sent using MAC frame headers containing three MAC addresses. By implication, either the From DS or the To DS subfield may be set to ‘1’ in each frame, but not both. Conversely “4-address mode” refers to an 802.11 wireless network in which frames are sent using MAC frame headers containing four MAC addresses. Setting both the From DS and To DS subfields to ‘1’ indicates that the frame is using the four-address format. See IEEE 802.11-2007, section 7.1.3.1.3.

The WEP 612 is coupled to the WAP 608 via a 3-address mode wireless link 616. Although not shown in the example of FIG. 6, other WEPs and/or non-WEP STA could be coupled to the WAP 608, as well. In a specific implementation, the WEP 612 includes a STA. In this paper, where it is not clear from context, a STA can generally refer to a WAP, a WEP, a non-WAP STA, or a non-WEP STA. The term “WEP” is defined in this paper as a STA that is an endpoint of a 3-address mode wireless network that is coupled to at least one EP.

The EPs 614 are coupled to the WEP 612 through a wired connection. It may be noted that “N” EPs 614 are depicted in the example of FIG. 6, but that N can equal one.

As used in this paper, the term “embodiment” means an embodiment that serves to illustrate by way of example and not necessarily by limitation.

1. A system comprising:
an intermediate access point (IAP) operationally connected to a station (STA) and a wireless access point (WAP) configured to send over a wireless medium a 3-address mode-compliant frame having a payload;
wherein, in operation:
the IAP receives the 3-address mode-compliant frame from the WAP;
the IAP obtains an IP address from the 3-address mode-compliant frame;
the IAP determines a destination media access control (MAC) address using the IP address, wherein the destination MAC address is not in the 3-address mode-compliant frame;
the IAP encapsulates the payload with a header including the destination MAC address;
the IAP sends the payload with the header that includes the destination MAC address to the STA.

2. The system of claim 1, further comprising the WAP.

3. The system of claim 1, further comprising the STA.

4. The system of claim 1, wherein the IAP is a first IAP and the STA is a second IAP.

5. The system of claim 1, wherein the destination MAC address is that of the STA.

6. The system of claim 1, wherein, in operation, the IAP puts the destination MAC address in a receiver address (RA) field of the header.

7. The system of claim 1, wherein the modified header is 4-address mode-compliant and wherein, in operation, the IAP puts the destination MAC address in a destination address (DA) field of the header.

8. The system of claim 1, wherein the IAP changes a receiver address (RA) field in the header from a MAC address of the IAP to the destination MAC address.

9. The system of claim 1, wherein the IAP changes a transmitter address (TA) field in the header from a MAC address of the WAP to a MAC address of the IAP.

10. A system comprising:
a bridge table;
a bridge table building engine coupled to the bridge table;
a bridging engine coupled to the bridge table;
wherein, in operation:
the bridge table building engine obtains a Media Access Control (MAC) address of a station associated with an intermediate access point (IAP) and a corresponding Internet Protocol (IP) address of the station;
the bridge table building engine stores the MAC address and the corresponding IP address in association with one another in the bridge table;
the bridging engine receives from a Wireless Access Point (WAP) over a wireless medium a WAP IP frame having a payload;
the bridging engine matches an IP address in the WAP IP frame to the corresponding IP address in the bridge table to identify the MAC address;
the bridging engine encapsulates the payload with a header including the MAC address in an address field to create an IAP frame;
the bridging engine sends the IAP frame in a downstream direction.

11. The system of claim 10, further comprising a registration engine that obtains the MAC address of the station during a registration procedure.

12. The system of claim 10, further comprising a snooping engine that obtains the corresponding IP address of the station from a configuration protocol message.

13. The system of claim 10, further comprising a snooping engine that obtains the corresponding IP address of the station from a Dynamic Host Configuration Protocol (DHCP) message.

14. The system of claim 10, further comprising a table interface engine that stores the MAC address and the corresponding IP address in association with one another in the bridge table.

15. The system of claim 10, further comprising a frame receive engine, including an antenna, that receives the WAP IP frame.

16. The system of claim 10, further comprising a client identification engine that matches the IP address in the WAP IP frame to the corresponding IP address in the bridge table to identify the MAC address.

17. The system of claim 10, further comprising an encapsulation engine that puts the MAC address in the header of the IAP frame.

18. The system of claim 10, further comprising a frame transmit engine, including an antenna, that sends the IAP frame downstream.

19. A method comprising:
receiving at an Intermediate Access Point (IAP) over a wireless medium a 3-address mode-compliant Wireless Access Point (WAP) Internet Protocol (IP) frame from a WAP;
using an IP address in the 3-address mode-compliant WAP IP frame to look up a corresponding Media Access Control (MAC) address in a bridge table;
encapsulating at least a portion of the WAP IP frame to include a Receiver Address (RA) field with the corresponding MAC address, thereby creating an IAP frame;
transmitting the IAP frame from the IAP toward a station (STA) that has the corresponding MAC address.

20. The system of claim 19, further comprising:
obtaining the MAC address of the STA through a registration process at the IAP;
snooping configuration protocol messages to obtain an IP address of the STA;
building the bridge table including the MAC address of the STA and the IP address of the STA stored in association with one another.
